(19) United States
(12) Patent Application Publication
(10) Pub. No.: US 2008/0021878 A1
(43) Pub. Date: Jan. 24, 2008

(54) Target Advertising Method And System Using Secondary Keywords Having Relation To First Internet Searching Keywords, And Method And System For Providing A List Of The Secondary Keywords

(76) Inventor: Eui Sin Jeong, Seoul (KR)

Correspondence Address: IPLA P.A., 3580 WILSHIRE BLVD., 17TH FLOOR, LOS ANGELES, CA, 90010, US

(21) Appl. No.: 11/572,133

(22) PCT Filed: Jul. 14, 2005
(86) PCT No.: PCT/KR05/02267

§ 371 Date: Jan. 15, 2007

(30) Foreign Application Priority Data
Jul. 16, 2004 (KR) 10-2004-0055347

(51) Int. Cl. G06F 7/10; G06F 17/30

(52) U.S. Cl. 707/3; 707/E17.14

(57) ABSTRACT

The present invention relates to an Internet keyword advertising method and, more particularly, to an advertising method and system, which, when a user demands keyword searching, provides secondary keywords related to a corresponding keyword, thus allowing the user to find the actual information and/or commodity sought through keyword searching via the Internet, and providing corresponding data. Furthermore, the present invention relates to a method and system for providing a list of secondary keywords related to primary keyword search. In accordance with the present invention, a user conducts a search using a primary keyword having a relatively comprehensive meaning and then conducts searches more detailed secondary keywords, so that information and/or commodity sought by the user can be easily found and checked. Meanwhile, an advertiser discloses his or her information and/or commodity to effective customers, connected through corresponding secondary keywords, so that the efficiency of advertising can be greatly improved.

### TECHNICAL FIELD

The present invention relates, in general, to an Internet keyword advertising method and, more particularly, to an advertising method and system, which, when a user request keyword searching, provides secondary keywords related to a corresponding keyword, thus providing data close to the information and/or commodity actually sought by users through keyword searching via the Internet.

Furthermore, the present invention relates to the provision of a list of related keywords when searching is carried out on a web site and, more particularly, to a method and system for providing a list of additional keywords related to a primary keyword, that is, a list of secondary keywords.

### BACKGROUND ART

Currently, the Internet functions as a new media for enabling communication between a company and individuals and between individuals and individuals in real time, rather than as a network for interconnecting computers. Therefore, interest in various advertisements on the Internet is increasing.

With an eye on the fact that a user, using a medium, inputs a specific keyword or a combination of keywords, into a search window, and thus searches for desired information, a conventional Internet keyword advertising method generally carries out advertising in such a way as to make a contract for advertisement of keyword intermediation for a predetermined period of time and expose the site of a specific company in an upper location or in a certain order using a keyword network center.

However, this method is problematic in that, when a user does not find a desired result in a screen resulting from keyword searching, a procedure of a user thinking up a keyword and inputting the new keyword into a search window must be performed again, so that inconvenience due to repetitive work is caused to the user.

Furthermore, even if the user inputs another keyword for searching again after a first search attempt, there is little difference in search results due to the similarity of keywords related to the identity of information and/or commodity sought by the user. Accordingly, there is inefficiency in that the user must respectively examine search results similar to the results of the first search attempt.

Furthermore, a problem occurs in that keywords, which are input into the search window of the medium by the user to search for certain information and/or commodity, are severely limited based on the user's usage pattern and, therefore, the types of advertisement keywords that can be profitably utilized by the advertiser are limited.

Furthermore, in the conventional advertising method, the range of the search results is limited to within the range of the user's experience because the user must know all keywords associated with information and/or commodity that are desired by the user, so that it is difficult to expect effective advertisement effects.

In the searching of web sites using the Internet, keyword searching is generally utilized. Therefore, a business model that links a search service and advertisements has become the principle source of income of Internet portal sites. However, existing keyword searching concentrates searches only on popular keywords. That is, as popular keyword-based searching is conducted, site registration, advertisement registration, and directory registration are also focused on the popular keywords. This causes poor search results for unpopular keywords and, therefore, the popular keyword-based searches further increase. Accordingly, focusing only on some popular keywords causes a lack of advertisement sales for a vast number of unpopular keywords.

### DISCLOSURE OF INVENTION

Technical Problem

Accordingly, an object of the present invention is to provide a target advertising method and system using secondary keywords related to primary Internet search words, in which details regarding information and/or commodity desired by users can be easily found, so that users' convenience can increase and an advertiser, utilizing keyword searches as an advertisement means, can improve advertisement effects.

Another object of the present invention is to provide searchers with additional keywords closely related to the searchers' search target, thus helping the searchers to quickly and easily find the search target.

Technical Solution

In order to accomplish the above object, the present invention provides an advertisement system having an FO server, the FO server including:

a keyword database for storing primary keywords, which will be input into a search window of a web browser driven by a medium server system, and secondary keywords, which will be output as search results when an advertiser designates and selects a certain word;

an advertiser database for storing advertisement information, having a Uniform Resource Locator (URL), in conjunction with the primary and secondary keywords;

an advertisement server having a keyword list generation module for extracting the secondary keywords, which are mapped according to a query of the medium server system for primary keyword from the keyword database, and generating a list by linking the secondary keywords with the advertisement information stored in the advertiser database, and a medium communication module for outputting the list through the web browser of the medium server system for an Internet user and receiving selection information with respect to the list;

a LOG server having an advertisement delivery information module for checking delivery of the corresponding advertisement information that is linked with the secondary keywords selected from the list by the Internet user, and generating delivery information data;

an advertisement delivery information database for storing the delivery information data; and

an advertisement delivery detail reading module for extracting requested delivery information data from the advertisement delivery information database at an on-line request from an advertiser and outputting the extracted delivery information data.

In the advertisement system according to the present invention, the LOG server may further include a user information module for checking at least one of an Internet Protocol (IP) address, cookie, session and search time of the user who selected the secondary keywords, and generating user information data; an alarm module for checking whether identical information is accumulated at predetermined intervals by analyzing the user information data, and performing communication with the advertiser of the corresponding keyword advertiser through mail and/or Short Message service (SMS) when an accumulated amount thereof exceeds a reference value.

In the advertisement system according to the present invention, the LOG server may further include a user information database for storing the user information data, the user information database being configured to operate in conjunction with the FO server, so that advertiser can read the user information data.

In the advertisement system according to the present invention, the FO server may further include a keyword amendment module that operates in conjunction with the keyword database and the advertiser database, and performs additions, deletions and changes on the keywords associated with the advertisement information at an on-line request from the advertiser.

The advertisement system according to the present invention may further including an payment database for storing cost data with respect to deposited money that has been deposited by the advertiser for advertisement costs, an amount of money that has been consumed depending on advertisement delivery and remaining amount of deposited money, operating in conjunction with the keyword list generation module so that the cost data is utilized as a parameter, which is applied to the generation of the 1 ist, by calculation of an amount of money to be consumed depending on a remaining amount of deposited money and advertisement delivery, and operating in conjunction with the FO server so as to allow the advertiser to read the cost data; wherein the FO server further comprises an accounting module for updating the cost data according to consumption of the deposited money caused by advertisement delivery, and additions to the deposited money caused by depositing money.

The advertisement system according to the present invention may further include a medium query information database for storing information data about queries of the medium server system; and a keyword complement module for extracting and analyzing the information data of the medium query information database, performing additions, deletions and changes on the primary keywords and the secondary keywords stored in the keyword database, and amending mapping between the primary keyword and the secondary keywords.

The advertisement system according to the present invention may further include a note system, the note system including a message delivery module for outputting a note form, which is attached to the list output to the medium server system, to a user's terminal according to selection of the Internet user, and sending a prepared message to the advertiser on-line; and a note database for storing details of the prepared message as data.

In order to accomplish the above object, the present invention provides an advertising method, including the primary keyword input step of transmitting and inputting a primary keyword from the user's terminal to the medium server system;

the query transmission step of transmitting a query regarding the primary keyword from the medium server system to the advertisement system;

the secondary keyword search step of determining whether one or more secondary keywords, which are mapped depending on relation to the primary keyword, exist in the database, in the advertisement system;

the advertisement information checking step of checking whether the one or more secondary keywords, which have been searched for, are linked with the advertisement information and/or the advertiser system, in the advertisement system;

the secondary keyword transmission step of transmitting the one or more secondary keywords to the user's terminal through the medium server system if it is determined that corresponding secondary keywords have been linked with the advertisement information and/or the advertiser system at the advertisement information checking step, in the advertisement system;

the advertisement information output step of connecting to the advertisement information and/or the advertiser system that is linked with the corresponding secondary keywords if one of the secondary keywords is clicked on or moused over by the user's terminal; and

the advertisement delivery information storing step of transmitting and storing delivery information data about advertisement delivery details, which result from the connection of the user's terminal to the advertisement information and/or the advertiser system through the secondary keywords, to and in the database of the advertisement system.

The advertising method according to the present invention may further include the user information extracting step of extracting user information from the user's terminal to which advertisements have been delivered, and storing the extracted user information in the database; the user information checking step of checking whether identical information of an amount exceeding a reference value and has been accumulated in the database at predetermined intervals, in the advertisement system; and the alarm step of transmitting alarm information from the advertisement system to the advertiser system if it is determined that the identical user information has exceeded the reference value at the user information checking step.

The advertising method according to the present invention may further include the deposited money checking step of checking whether the delivery of an advertisement is possible by calculating money to be consumed based on to the amount of remaining deposited money stored in the database; and delivering an advertisement, if it is determined that the corresponding secondary keywords have been linked with the advertisement information and/or the advertiser system at the advertisement information checking step, in the advertisement system; and the deposited money information updating step of performing update on the deposited money by consuming the remaining amount of the deposited money, which is stored in the database, corresponding to advertisement delivery cost, if an advertisement is delivered, in the advertisement system.

In the advertising method according to the present invention, at the secondary keyword transmitting step, the secondary keywords are transmitted in a sentence form including desired secondary keywords to be transmitted.

In order to accomplish the above object, the present invention provides another method of providing a list of secondary keywords, the method including the steps of:

receiving a search request signal for a primary keyword;

providing search results and category information about the primary keyword when the search request signal for the primary keyword is input;

receiving a category selection signal based on the category information; and

providing secondary keywords of a corresponding category in response to the input category selection signal.

the method of providing a list of secondary keywords according to the present invention may further include the step of providing priority secondary keywords that correspond to the primary keyword, when the search request signal associated with the primary keyword is input.

The secondary keywords of the present invention may be extracted from keywords that have been previously searched for by users using the primary keyword. Furthermore, the present invention of the present invention may be limited so as not to be exposed after a primary keyword search.

Furthermore, the secondary keywords of the present invention may be arranged depending on a degree of similarity with the primary keyword, search frequency, and the number of inserted advertisements.

The method of providing a list of secondary keywords according to the present invention may further include the steps of receiving a signal for selecting one from among the provided secondary keywords; and providing search results for the selected secondary keyword.

The method of providing a list of secondary keywords according to the present invention may further include the steps of receiving a keyword history request signal; and allowing searched keywords to be displayed according to search order after the searching for the primary keyword.

The method of providing a list of secondary keywords according to the present invention may further include the step of generating a keyword database in which secondary keywords corresponding to the primary keyword are classified according to category, the secondary keywords being read from the keyword database.

In the method of providing a list of secondary keywords according to the present invention, a predetermined number of secondary keywords are provided at one time, and another predetermined number of secondary keywords are provided at an additional request of a user, the additional request being received through an interface that is displayed on the terminal of a searcher and has a search jog form.

In order to accomplish the above object, the present invention provides a further method of providing a list of secondary keywords, the method including the steps of:

generating a keyword database in which keywords are classified according to predetermined category;

receiving a keyword;

providing category information corresponding to the input keyword; and

reading keywords of a corresponding category from the keyword database and providing the read results, if selection of the category is performed according to the provided category information.

In order to accomplish the above object, the present invention provides yet another method of providing a list of secondary keywords, the method including the steps of:

generating a keyword database in which keywords are classified according to pre-determined category;

providing search category information in response to a request for connecting to a web site; and

providing keywords of a corresponding category in response to a category selection signal when the category selection signal is input according to the provided category information.

In order to accomplish the above object, the present invention provides a web server for providing a list of secondary keywords, the web server including:

a keyword database configured such that the secondary keywords corresponding to a primary keyword are classified according to predetermined category;

means for providing search results, for the primary keyword, category information, and priority secondary keywords, when a search request signal resulting from the primary keyword is input; and

means for reading secondary keywords of a corresponding category from the keyword database in response to a category selection signal and providing the read results, when the category selection signal is input based on the provided category information.

### BRIEF DESCRIPTION OF THE DRAWINGS

FIG. 1 is a schematic diagram showing the construction of a user's terminal, a medium server system and an advertiser system that are connected to an advertising system via the Internet in accordance with the present invention;

FIG. 2 is a diagram showing a first scheme in which an advertisement handled by the advertising system is displayed through the web browser of a medium server system in accordance with the present invention;

FIG. 3 is a diagram showing the detailed construction of the user's terminal, the medium server system and the advertiser system that are connected to the advertising system via the Internet in accordance with a first embodiment of the present invention;

FIG. 4 is a diagram showing the detailed construction of the user's terminal, the medium server system and the advertiser system that are connected to the advertising system via the Internet in accordance with a second embodiment of the present invention;

FIG. 5 is a diagram showing the detailed construction of the user's terminal, the medium server system and the advertiser system that are connected to the advertising system via the Internet in accordance with a third embodiment of the present invention;

FIG. 6 is a diagram showing the detailed construction of the user's terminal, the medium server system and the advertiser system that are connected to the advertising system via the Internet in accordance with a fourth embodiment of the present invention;

FIG. 7 is a diagram showing the detailed construction of the user's terminal, the medium server system and the advertiser system that are connected to the advertising system via the Internet in accordance with a fifth embodiment of the present invention;

FIG. 8 is a flowchart illustrating an advertising method according to the present invention;

FIG. 9 is a detailed flowchart illustrating the keyword list establishment step of FIG. 8;

FIGS. 10 and 11 are flowcharts illustrating first and second examples, respectively, of an advertisement delivery step through the keyword searching of FIG. 8;

FIG. 12 is a detailed flowchart illustrating the first example of the advertisement delivery step through the keyword searching of FIG. 8;

FIGS. 13 and 14 are detailed flowcharts illustrating second and third examples, respectively, of the advertisement delivery step through the keyword searching of FIG. 8;

FIG. 15 is a diagram showing the construction of an overall system for providing a list of secondary keywords related to the search for a primary keyword in a web site in accordance with the present invention;

FIG. 16 is a diagram showing an example of secondary keywords in the case where the primary keyword is “computer” in accordance with the present invention;

FIG. 17 is a flowchart illustrating the method of providing the secondary keywords in accordance with an embodiment of the present invention;

FIG. 18 is a detailed flowchart illustrating the method of providing the secondary keywords in FIG. 17;

FIG. 19 is a diagram illustrating an example in which a category and the secondary keywords are displayed on searcher terminals in the case in which the primary keyword is “computer” in accordance with the present invention;

FIG. 20 is a diagram illustrating an example in which the secondary keywords, already exposed, are not exposed upon subsequent searching within a selected category, in accordance with the present invention;

FIG. 21 is a flowchart illustrating a method of providing a keyword history map in accordance with the present invention;

FIG. 22 is a diagram illustrating an example of the keyword history map provided in the present invention;

FIG. 23 is a flowchart illustrating a method of providing secondary keywords in accordance with another embodiment of the present invention; and

FIG. 24 is a diagram illustrating a search jog interface in accordance with the present invention.

### BEST MODE FOR CARRYING OUT THE INVENTION

The present invention is described in detail with reference to the accompanying drawings below.

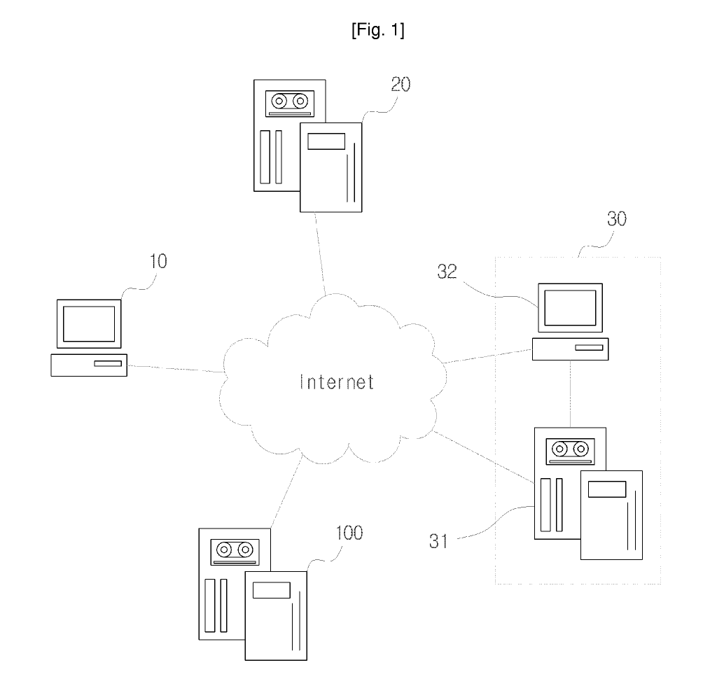

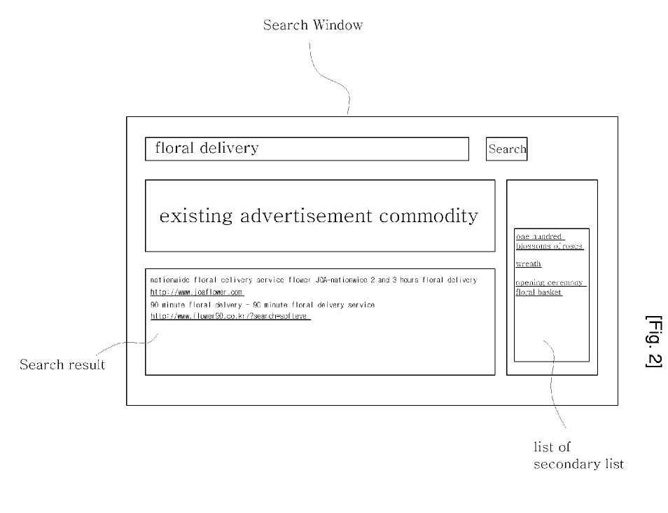

FIG. 1 is a schematic diagram showing the construction of a user's terminal, a medium server system and an advertiser system that are connected to an advertising system via the Internet in accordance with the present invention, and FIG. 2 is a diagram showing a first scheme in which an advertisement handled by the advertising system is displayed through the web browser of a medium server system in accordance with the present invention. Descriptions are made with reference to FIGS. 1 and 2.

As shown in FIG. 1, the advertising system 100 according to the present invention performs communication with the user's terminal 10, the medium server system 20 and the advertiser system 30 via the Internet, and performs intermediation work between the advertiser system 30 corresponding to an advertisement producer, and the user's terminal 10 corresponding to an advertisement customer.

The user's terminal 10 is a communication means that an Internet user uses to access via the Internet.

The medium server system 20 operates sites that provide a number of searching services existing in various forms on the Internet, and transmits and receives corresponding information using a web browser as a means while communicating with the user's terminal 10.

The advertiser system 30 operates companies' homepage sites or Internet shopping mall sites, and transmits and receives corresponding information using a web browser as a means while communicating with the user's terminal 10 via the Internet.

Through the above-described mechanism, an Internet user connects to a site operated by the medium server system 20 and inputs an arbitrary keyword into a search window to acquire necessary information, as shown in FIG. 2. The medium server system 20 searches for and outputs the results of the input search word. Furthermore, in the search process, the medium server system 20 transmits a query, which is associated with the corresponding search word, to the advertisement system 100, and the advertisement system 100, which has received the query, extracts one or more different keywords related to the search word and transmits the extracted keywords, along with advertisement information, to the medium server system 20. The medium server system 20, having received the keywords and advertisement information, outputs a list of secondary keywords, along with existing advertisement commodity and the search results, to the user's terminal 10.

The term search word refers to a primary keyword, and the term additional keywords, which is related to the primary keyword input as the search words, refers to secondary keywords. A method of selecting the secondary keywords is described in detail below.

First, an example of the method of selecting the secondary keywords is a pattern keyword method. A pattern keyword refers to the type of a keyword search for requesting the search of specific information when a user, using a general searching medium, performs a keyword search to acquire information through the searching medium. Users use a method of requesting searches using general keywords, and then requesting searches using gradually more detailed keywords in order to search for specific information in the search medium.

The reason why the above-described method is used is because, when the search engines of current search media collect information, they analyze significant words (keywords) by comparing textual information in web documents, which are provided through the Internet, with dictionary databases, which are retained by the search engines, and, when users request information search with respect to keywords through the search media, they generates and provide search result screens based on the analysis included in a result list.

A search engine extracts a list of keywords for web documents based on the previously defined dictionary database and thereby generates search results. For these reasons, how exact search results and how many keywords are extracted is determined depending on the technology applied to each search medium. Accordingly, it is necessary for the user to request various types of searches so as to acquire desired information. That is, the user searches for sought information in such a manner that he or she primarily requests a search for a general keyword that enables the acquisition of many search results, and acquires additional information by visiting a web page closely related to sought information, or reduces the range of provided information by requesting subsequent searches for the detailed ones of the search results.

A user, requesting a search through an Internet search medium, requests a search for information about various keywords from the search engine of the search medium so as to acquire sought information. In order to provide the exact information requested by the user, the search medium stores a list of keywords and search history in a database, analyzes them, and accumulates the analyzed results within the dictionary database of the search engine. Keywords bearing relation to each other in the list of keywords accumulated in this process, that is, the list of keywords for which searches were requested by the user, can be called pattern keywords.

The present invention may use a method of providing the remaining words as secondary keywords using pattern keywords established as described above.

In the present invention, other methods for selecting the secondary keywords include a recommended keyword method. In this case, recommended keywords refer to pattern keywords that are most frequently requested from among pattern keywords generated by analyzing the user's keyword search pattern to provide exact information in the search medium.

Due to the variety of information search purposes, the recommended keywords, which are provided for relatively fast search results by providing a list of search words that the previous users frequently used and belongs to various pattern keyword types collected in advance by the search engine, may be usefully applied to a method of selecting secondary keywords according to the present invention when a user requests representative keywords or detailed keywords from the search engine to search for information.

Another method of selecting secondary keywords according to the present invention uses keywords having a commercial value as a keyword search advertisement in a pattern keyword list that is finally established, other keywords or the combination thereof being extracted from a web document having a primary keyword or the combination thereof as secondary keywords.

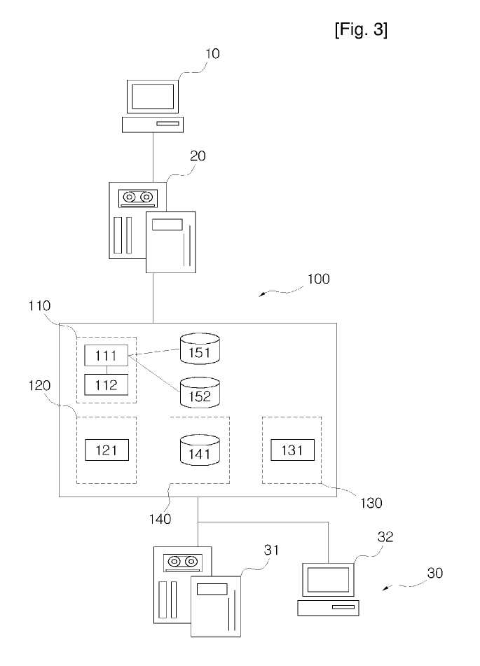

FIG. 3 is a diagram showing the detailed construction of the user's terminal, the medium server system and the advertiser system that are connected to the advertising system via the Internet in accordance with a first embodiment of the present invention. Descriptions are made with reference to FIG. 3.

The advertisement system 100 according to the present invention includes a keyword database 151 for storing primary keywords that will be input into the search window of web browser operated by a medium server system 20, and secondary keywords that will be output as search results when an advertiser designates and selects a certain word, an advertiser database 152 for storing advertisement information having a Uniform Resource Locator (URL), in conjunction with the primary and secondary keywords, an advertisement server 110 having a keyword list generation module 111 for extracting secondary keywords, which are mapped according to a query of the medium server system 20 for the primary keyword from the keyword database 151, and generating a list by linking the secondary keywords to the advertisement information stored in the advertiser database 152, and a medium communication module 112 for outputting the list through the web browser of the medium server system 20 for an Internet user and receiving selection information with respect to the list, a LOG server 120 having an advertisement delivery information module 121 for checking execution details of the corresponding advertisement information that operates in conjunction with the secondary keywords selected from the list by the Internet user, and generating delivery information data, an advertisement delivery information database 141 for storing the delivery information data, and an advertisement delivery detail reading module 131 for extracting requested delivery information data from the advertisement delivery information database 141 at the on-line request of an advertiser and outputting the extracted delivery information data.

The relationship between the primary keyword and the secondary keywords is described with reference to FIG. 2. Secondary keywords, such as “one hundred blossoms of roses,” “wreath,” and “opening ceremony floral basket,” which are registered in a secondary keyword list and correspond to a primary keyword “floral delivery,” are associated with the primary keyword and are formed of keywords having more functional meanings than the primary keyword. Accordingly, although an Internet user, desiring to send a flower to an opening ceremony, inputs a primary keyword, “floral delivery,” into a search window, desired information can be immediately acquired without individually checking numerous search results. The secondary keywords have been linked with advertisement information, so that the Internet user can connect to an advertiser system 30 through a URL included in corresponding advertisement information when he or she selects a corresponding secondary keyword

The advertiser database 152 stores the advertisement information in data form.

The keyword list generation module 111 searches for and extracts corresponding secondary keywords according to a query that is transmitted from the medium server system 20 to output search results according to the primary keyword, and also extracts pieces of advertisement information that are linked with the secondary keywords, thus generating a list of the secondary keyword. In this case, the primary keyword and the secondary keywords are mapped according to correlation described above, so that the keyword list generation module 111 searches for the secondary keywords according to the logic thereof.

When secondary keywords and the advertisement information thereof that are transmitted from the advertisement server 110 to the medium server system 20 are selected by the Internet user, the advertisement delivery information module 121 checks various information with respect to advertisement delivery, and generates delivery information data about an advertisement delivery time, an advertisement delivery frequency, and medium information by which advertisement delivery has been performed.

The advertisement delivery information reading module 131 allows the advertiser to connect to the advertisement system 100 using the advertiser terminal 32 of the advertiser system 30 and to then check details with respect to the advertisement delivery, extracts necessary delivery information data at the request of the advertiser and outputs the extracted results to the advertiser terminal 32, while operating in conjunction with the advertisement delivery information database 141.

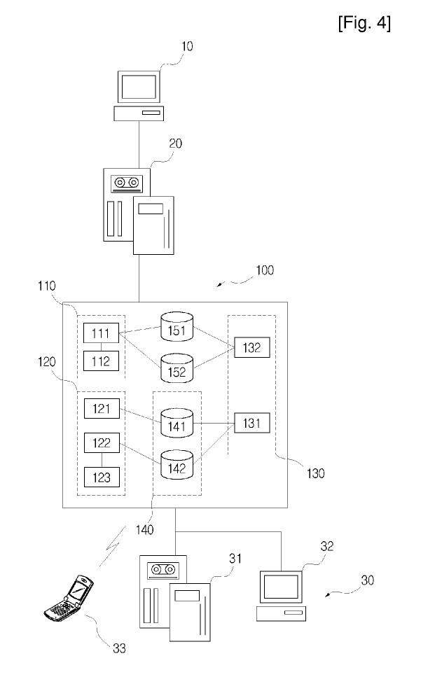

FIG. 4 is a diagram showing the detailed construction of the user's terminal, the medium server system and the advertiser system that are connected to the advertising system via the Internet in accordance with a second embodiment of the present invention, and descriptions are made with reference to FIG. 4.

The LOG server 120 further includes a user information module 122 for generating user information data by checking at least one of the Internet Protocol (IP) address, cookie, session, and time items of the Internet user who selected the secondary keywords, an alarm module 123 for checking whether the same information is accumulated at predetermined intervals by analyzing the user information data, and communicating with the advertiser of the corresponding keyword through mail and/or Short Message service (SMS) when the accumulated amount thereof exceeds a reference value, and a user information database 142 for storing the user information data, the user information database being configured to operate in conjunction with the FO server, so that the user can read the user information data.

The user information module 122 and the alarm module 123 are used to confirm that qualified customers have viewed advertisements, thus allowing the advertiser to trust advertisement delivery.

The user information module 122 selects secondary keywords, tracks the terminal 10 of a user, who views advertisements that are linked with the secondary keywords, generates the IP address, cookie and session of the user's terminal, and the user information data that enables the checking of the delivery time, and then stores the user information data in the user information database 142.

The alarm module 123 checks the accumulated amount of the same information at a predetermined intervals while analyzing the user information data stored in the user information database 142 in real time. That is, if a click or a mouse-over for the corresponding secondary keyword occurs continuously from the same IP within a predetermined time, the user information module 122 generates the user information data regarding the same IP in real time and stores them in the user information database 142 and the alarm module 123 checks the accumulated amount. In this case, if the accumulated amount exceeds a reference value, the alarm module 123 determines that an inappropriate advertisement has been delivered and sends the determination to the advertiser system 130. Generally, the sending means may utilize mail or SMS.

Meanwhile, the user information database 142 allows the advertiser to directly search the user information database 142 while operating in conjunction with the advertisement delivery detail reading module 131.

The FO server 130 further includes a keyword amendment module 132 that operates in conjunction with the keyword database 151 and the advertiser database 152, and performs addition, deletion and change on the keywords associated with the advertisement information at the on-line request of the advertiser.

The keyword amendment module 132 provides an Internet format, in which a keyword to be linked with the advertisement information of the advertiser can be selected or changed, to the advertiser system 30 and, therefore, the advertiser allows the keyword to be directly changed on the Internet using their own advertiser terminal 32. Furthermore, the keyword amendment module 132 may compose secondary keywords, which do not exist, according to need, and apply them to the execution of advertisements. Furthermore, the keyword amendment module 132 may amend the advertisement information, and updates data stored in the keyword database 151 and the advertiser database 152 through this procedure.

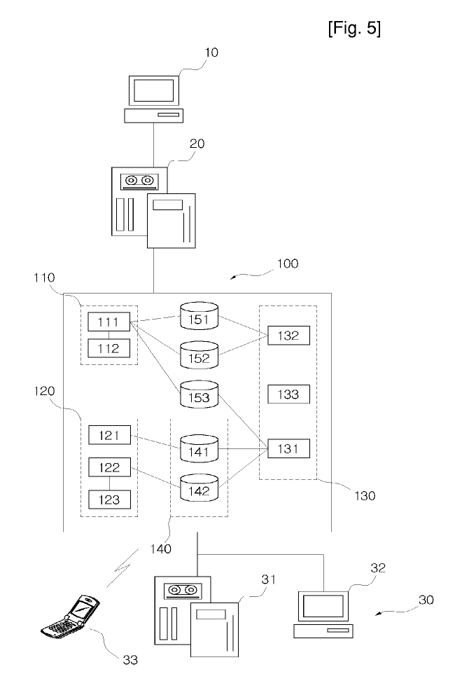

FIG. 5 is a diagram showing the detailed construction of the user's terminal, the medium server system and the advertiser system that are connected to the advertising system via the Internet in accordance with a third embodiment of the present invention. Descriptions are made with reference to FIG. 5.

The advertisement system further includes an payment database 153 an payment database 153 for storing cost data with respect to deposited money that has been deposited by the advertiser for advertisement costs, an amount of money that has been consumed depending on advertisement delivery and remaining amount of deposited money, operating in conjunction with the keyword list generation module 111 so that the cost data is utilized as a parameter, which is applied to the generation of the list, by calculation of an amount of money to be consumed depending on a remaining amount of deposited money and advertisement delivery, and operating in conjunction with the FO server 130 so as to allow the advertiser to read the cost data. The FO server 130 further includes an accounting module 133 for updating the cost data depending on consumption of the deposited money caused by advertisement delivery, and additions to the deposited money caused by depositing money.

Generally, the advertisement system 100 earns revenue by linking the advertiser, who is an advertisement producer, to the Internet user, who is an advertisement customer, and charging a fee. In this case, an advertising method according to the present invention adopts a so-called “measured rate system” as an example of charging a fee. That is, deposited money from the advertiser is paid in advance for an advertisement intermediation cost, and is subtracted according to a cost for a single exposure.

The accounting module 133 extracts cost data from the payment database 153, and updates the cost data based on consumed and deposited money in real time. Furthermore, when the advertiser additionally deposits the deposited money, the accounting module 133 updates the cost data according to the additionally deposited cost and stores the updated cost data in the payment database 153.

The payment database 153, as described above, stores cost data about deposited money paid in advance as an advertisement intermediation cost and the deposited money remaining after being consumed, and performs the following main functions while operating in conjunction with the FO server 130 and the keyword list generation module 111.

First, the FO server 130 allows the advertiser, connecting to the advertisement system 100 using an advertiser terminal 32, to perform various functions, such as viewing details of consumed and deposited money, the adding of deposited money, and requesting repayment of deposited money, while particularly operating in conjunction with the advertisement delivery detail reading module 131.

When generating a list of secondary keywords according to a query transmitted from the medium server system 20, the keyword list generation module 111 allows information about the deposited money to be applied to the generation of the list of the secondary keywords. That is, when the list of the secondary keywords is generated by the query while the payment database 153 and the keyword list generation module 111 operate in conjunction with each other, an amount of money for executing advertisement information linked with a certain secondary keyword is compared to the remaining deposited money. In this case, the advertisement information linked with the secondary keywords may be omitted from the database if the amount of money is not sufficient.

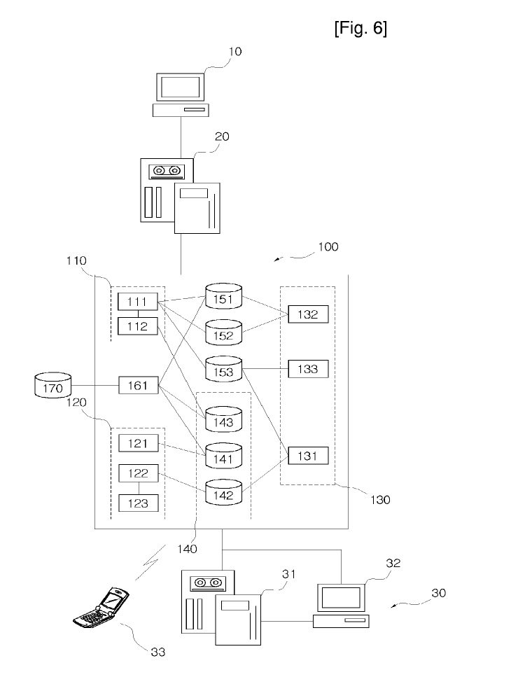

FIG. 6 is a diagram showing the detailed construction of the user's terminal, the medium server system and the advertiser system, connected to the advertising system via the Internet in accordance with a fourth embodiment of the present invention. Descriptions are made with reference to FIG. 6.

The advertisement system further includes a medium query information database 143 for storing information data about the queries of the medium server system 20, and a keyword complement module 160 for extracting and analyzing the information data of the medium query information database 143, performing addition, deletion and change on the primary keyword and the secondary keywords stored in the keyword database 151, and amending mapping between the primary keyword and the secondary keywords.

Although, in relation to the keyword database 151, a designer must select the primary keyword and the secondary keywords, perform mapping on the selected keywords, and then store the mapped keywords, the update of the keyword database 151 is necessary to keep up with search words that vary with every day. For this purpose, the medium query information database 143 receives and stores the query transmitted from the medium server system 20, that is, information data that correspond to a primary keyword input through a search window by an Internet user.

The keyword complement module 160 complements the primary and secondary keywords, which are previously stored in the keyword database 151, while operating in conjunction with the medium query information database 143, the advertisement delivery information database 141, and the keyword database. That is, the keyword complement module 160 checks a mainly input search word (primary keyword) by analyzing the medium query information database 143, and allows mapping between the primary keyword and the secondary keywords to be amended if the input rate thereof increases somewhat. Furthermore, the keyword complement module 160 analyzes the advertisement delivery information database 141, so that, for the primary and secondary keywords of which advertisement delivery is frequent, it allows keywords similar to the corresponding primary and secondary keywords to be added, or, for the primary and secondary keywords of which advertisement delivery is relatively small, it allows details, such as the deletion of the keywords, to be checked or examined. In this case, a significant word database 170 may be further included to search for words that will be used as necessary keywords.

Meanwhile, in the above-described details, a detail of the mapping of the primary and secondary keywords is made in more detail by taking an example.

The primary keyword is a search word input to the medium server system 20 by the Internet user, and the secondary keywords are keywords that are extracted from the keyword database 151 according to the query of the medium server system 20 with respect to the primary keyword. The primary keyword can be regarded as an upper concept in contrast to the secondary keywords (refer to a search window and a list of secondary keywords in FIG. 2).

Accordingly, the advertiser may contrive, select or designate various words or sentences associated with or related to a single keyword, such as “floral delivery”. In this case, it is advantageous in that the words used as the secondary keywords are necessarily popular search words. Furthermore, since the secondary keywords originate from a single primary keyword, there is an advantage in that a plurality of advertisers can utilize a single keyword, such as “floral delivery.”

Meanwhile, of the secondary keywords, some keywords may be ranked as popular keywords according to variation in social conditions and Internet cultures. The keyword complement module 160 performs amendment so that the above-described words or sentences, which are mapped using the secondary keywords, can be utilized as primary keywords through the data of the medium query information database 143 and the advertisement delivery information database 141. The data of the keyword database 151 are updated in such a way as to select secondary keywords corresponding to the amended primary keyword again.

Thereafter, in the case where the number of the secondary keywords that are output as the search results of the primary keyword is more than two, it is necessary to determine the order thereof. The order may be determined by a random automation rolling method, or a method of imposing a differentiated advertisement cost according to location. That is, in the case in which, among secondary keywords, such as “one hundred blossoms of roses,” “wreath,” “opening ceremony floral basket,” and “one hundred blossoms of roses,” a certain advertiser designates “one hundred blossoms of roses” as a secondary keyword and other advertisers designate “wreath” and “opening ceremony floral basket” as secondary keywords, the second keyword, “one hundred blossoms of roses,” has priority in a list of secondary keywords searched according to the primary keyword called “flower delivery,” if the advertiser, having designated “one hundred blossoms of roses, sets an higher advertisement cost than advertisers having different keywords.

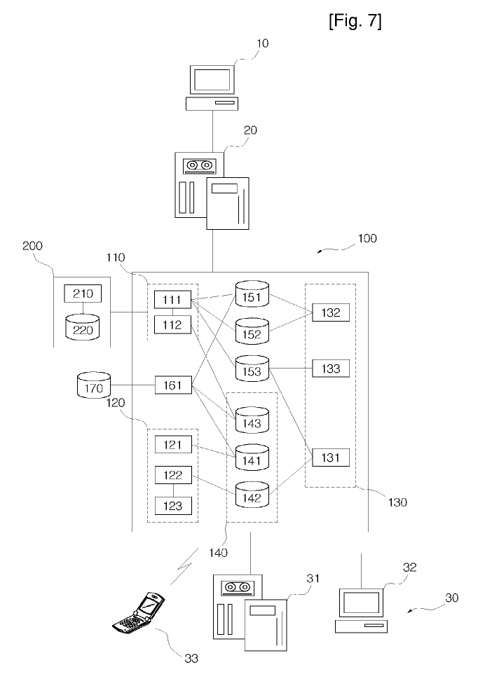

FIG. 7 is a diagram showing the detailed construction of the user's terminal, the medium server system and the advertiser system, connected to the advertising system via the Internet in accordance with a fifth embodiment of the present invention. Descriptions are made with reference to FIG. 7.

The advertisement system further includes a note system 200, the note system 200 including a note execution module 210 for outputting a note form, which is attached to the list output to the medium server system 20, to a user's terminal 10 according to selection of the Internet user, and sending a prepared message to the advertiser on-line, and a note database 220 for storing the details of the prepared message as data.

The advertisement system further includes a note database 220, the note database including a note execution module 210 for outputting a note form to the user's terminal 10 according to an Internet user and sending the prepared message to the advertiser online, the note form being attached to the list output to the medium server system 20, and a note database 220 for storing the details of the prepared message as data.

The note system 200 sends an inquiry to the advertiser corresponding to advertisement information, which is associated with the corresponding secondary keywords, in note form before the Internet user accesses the corresponding advertiser system 30 by selecting one from among the list of secondary keywords. The recipient of the note may be all of the advertisers corresponding to advertisement information linked with the secondary keywords, may be one of the advertisers, or may be different advertisers who do not use the secondary keywords because the number of the secondary keywords included in the list is limited.

In this case, a note sending cost can be subtracted from the deposited money based on note sending deposit. Charging methods include a method of making charges when the Internet user sends a note to the advertiser, and a method of making charges when the advertiser sends response to the Internet user who sent the note. These charging methods may variously vary with variation in policy.

Meanwhile, the advertisement system 100 according to the present invention inputs scripts to the advertiser system 30 in advance to check advertisement effects, thus checking the information of the Internet user connected to the advertiser system 30 via the advertisement system 100, and their actions (commodity purchasing, entrance for membership). The corresponding information is stored in a database, but the database is omitted in FIG. 7.

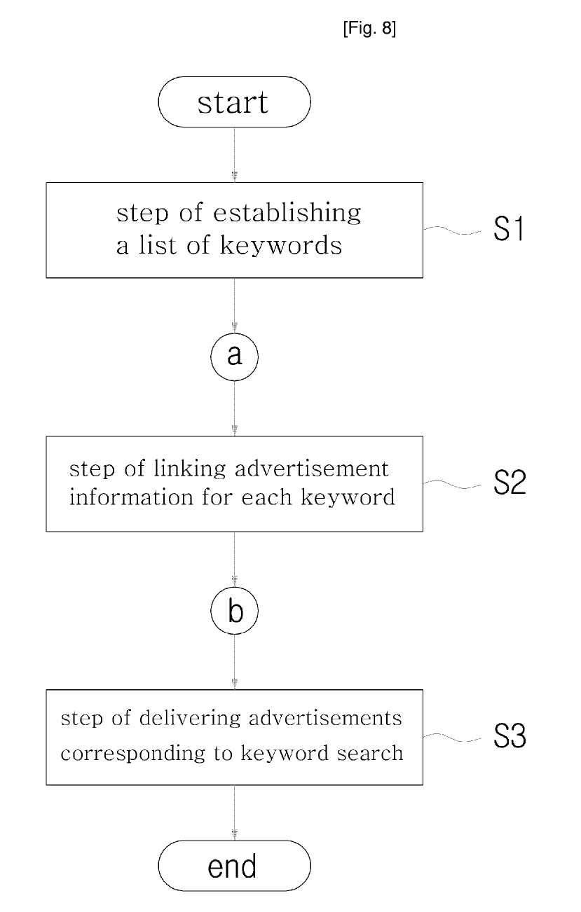

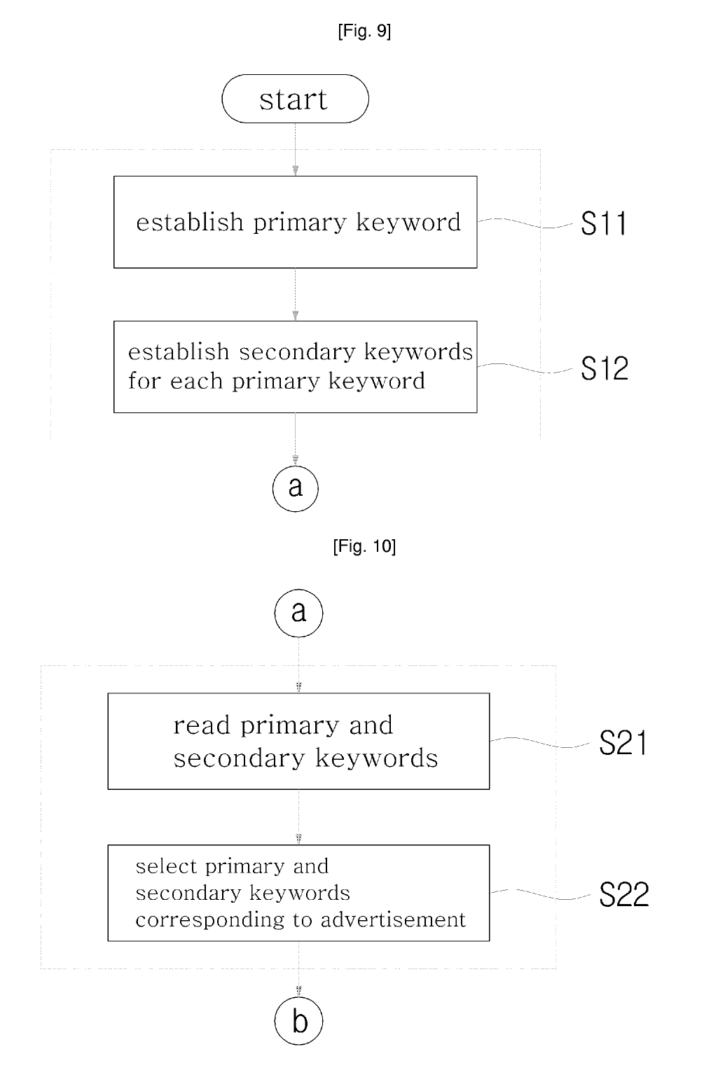

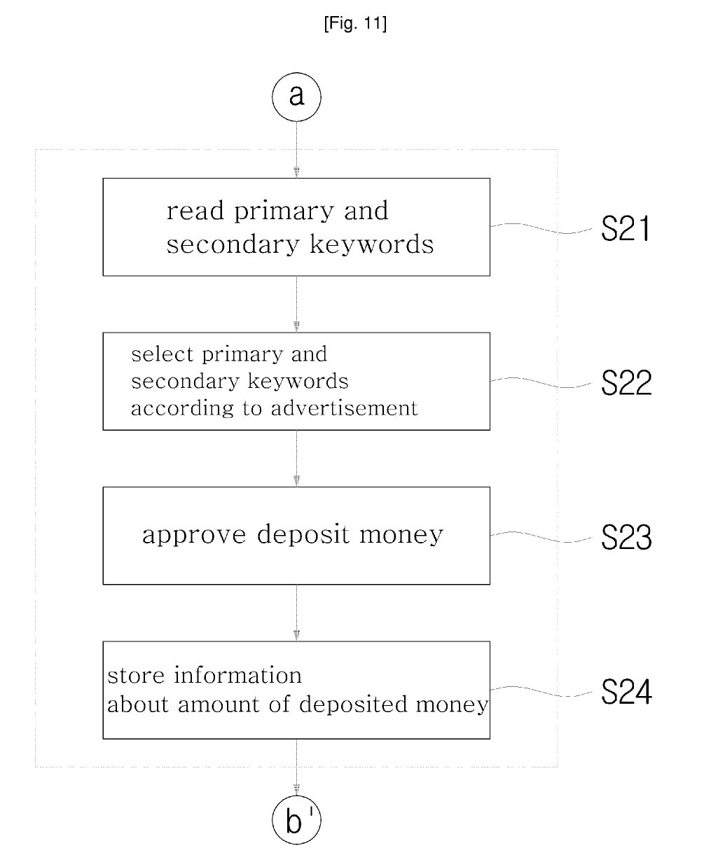

FIG. 8 is a flowchart illustrating an advertising method according to the present invention, FIG. 9 is a detailed flowchart illustrating the keyword list establishment step of FIG. 8, and FIGS. 10 and 11 are flowcharts illustrating first and second examples, respectively, of an advertisement delivery step through the keyword searching of FIG. 8. Descriptions are made with reference to the drawings.

The Internet user searches for necessary information through the medium server system 20 and, thereby, search results are output. In relation to the following process performed according to the output search results, an advertising method according to the present invention is performed as part of the entire following process.

In the advertisement system 100 including the user's terminal 10, the medium server system 20, the advertiser system 30, and at least one database and server, the entire above-described process, as shown in FIG. 8, includes the list establishment step S1 of storing search keywords in the database of the advertisement system 100, the advertisement information link step for each keyword S2 of linking the advertisement information of the advertiser system 30 with one ore more keywords that are stored in the database, and the advertisement delivery step through keyword search S3 of transmitting a query for keywords from the medium server system 20 to the advertisement system 100 when the keyword is transmitted and input from the user's terminal 10 to the medium server system 20, and connecting to corresponding advertisement information by clicking and mousing over keywords, which are linked with advertisement information according to the query, when the advertisement information linked according to the query is transmitted from the advertisement system 100 to the medium server system 20.

In this case, the keyword list establishment step S1 is subdivided into the primary keyword database establishment step S11 of designating and selecting some keywords from among keywords input into the search window of the medium server system 20 and storing the selected keywords in a database, and the secondary keyword database establishment step for each primary keyword S21 of outputting certain words, which have been designated and selected by the advertiser, as the search results of the primary keyword according to mapped details.

Meanwhile, the advertisement information link step S2 is subdivided into the primary and secondary keyword reading step S21 of the advertiser reading the primary keyword and the secondary keywords stored in the database, and the primary and secondary keyword selection step S22 of designating and selecting appropriate primary keyword and secondary keywords from among the primary keyword and the secondary keywords based on the type, characteristic or function of an advertisement target. In addition, the deposited money payment step S23 of the advertiser receiving money in advance for the purpose of the payment of costs corresponding to advertisement intermediation. The deposited money information storing step S24 of storing the details of the received deposited money in a database may be further included when the advertisement intermediation is provided as a charged service.

Meanwhile, the advertisement delivery step through the keyword search S3 is an advertising method according to the present invention, and details of the step are made in detail below.

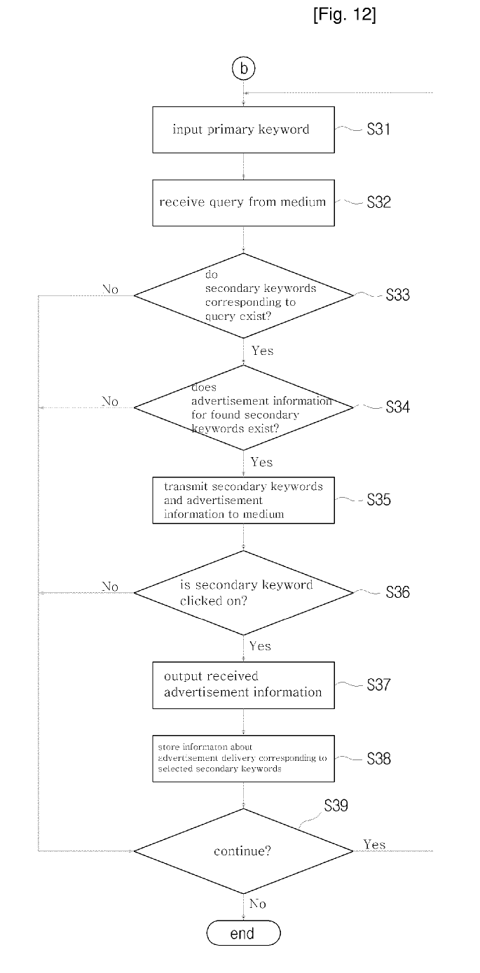

FIG. 12 is a detailed flowchart illustrating the first example of the advertisement delivery step through the keyword searching of FIG. 8. Descriptions are made with reference to FIG. 12.

The advertising method according to the present invention is performed on the Internet using the advertisement system 100 having the user's terminal 10, the medium server system 20, the advertiser system 30, and at least one database and server, the advertising method including:

(1) The primary keyword input step S31 of transmitting and inputting a primary keyword from the user's terminal 10 to the medium server system 20.

The Internet user connects to the medium server system 20 using the user's terminal 10 and then inputs the primary keyword into a search window to receive a search service.

(2) The query transmission step S32 of transmitting a query regarding the primary keyword from the medium server system 20 to the advertisement system 100.

The Input primary keyword is used to separately search for output results in the database of the medium server system 20 and, at the same time, to transmit a query for the primary keyword to the advertisement system 100.

(3) The secondary keyword search step S33 of determining whether the one or more secondary keywords, which are mapped depending on relation to the primary keyword, exist in the database, in the advertisement system 100.

The advertisement system 100 checks whether the secondary keywords, which are the output results of the primary keyword, exist according to the query. Generally, since the primary keyword is limited, it is apparent that a corresponding primary keyword and mapped secondary keywords do not exist when a query is transmitted for a primary keyword, which does not exist in the database, from the medium server system 20. Accordingly, the advertising method according to the present invention will be terminated at this time because the results thereof cannot be output. When one or more secondary keywords exist, a subsequent step will be performed with the generation of a list of secondary keywords.

(4) The advertisement information checking step S34 of checking whether the one or more secondary keywords, which have been searched for, are linked with the advertisement information and/or the advertiser system 30, in the advertisement system 100.

If corresponding keywords are not selected by the advertiser and, thereby, linked advertisement information does not exist even through it is determined through the secondary keyword search step S33 that the secondary keywords corresponding to the primary keyword exist in the database, the secondary keywords are not useful even through the seconds keywords are included in the list of secondary keywords. Accordingly, it is preferred that such keywords be removed.

(5) A secondary keyword transmission step S35 of transmitting the one or more secondary keywords to the user's terminal 10 through the medium server system 20 if it is determined that corresponding secondary keywords have been linked with the advertisement information and/or the advertiser system 30 at the advertisement information checking step S34, in the advertisement system 100.

When the list of secondary keywords is prepared through the steps, the corresponding data are transmitted to the medium server system 20, and the medium server system 20, having received the corresponding data, outputs them to the user's terminal 10 through a web browser. In this case, only the secondary keywords can be presented, and the secondary keywords may be also presented in sentence form.

(6) The advertisement information output step S37 of connecting to the advertisement information and/or the advertiser system 30 that is linked with the corresponding secondary keywords if one of the secondary keywords is clicked on or moused over by the user's terminal 10.

When a certain secondary keyword is selected from the list of secondary keywords output from the user's terminal 10, the Internet user can acquire the information, which he or she needs, from a site operated by the advertiser system 30 while the advertiser system 30 and the user's terminal 10 are connected according to advertisement information linked with the selected secondary keyword.

(7) The advertisement delivery information storing step S38 of transmitting and storing delivery information data about advertisement delivery details, which result from the connection of the user's terminal 10 to the advertisement information and/or the advertiser system 30 through the secondary keywords, to and in the database of the advertisement system 100.

Pieces of necessary information with respect to advertisements delivered while the Internet user connects to the advertiser system 30, that is, an advertisement delivery time and delivery information data about a medium to which advertisements are delivered, are stored in a database, so that the advertiser can search the database, in which the delivery information data are stored, on-line.

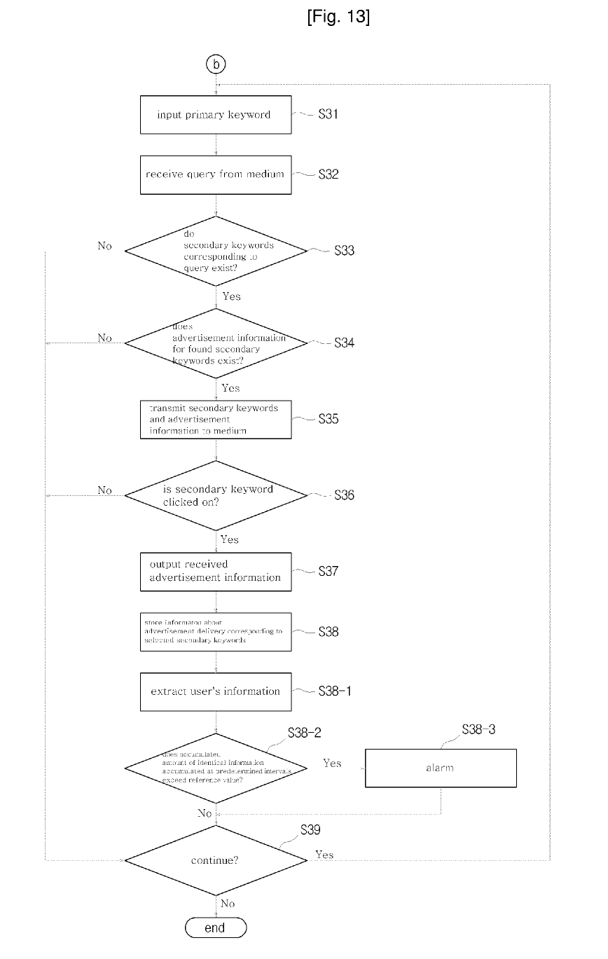

FIG. 13 is a detailed flowchart illustrating the second example of the advertisement delivery step through the keyword searching of FIG. 8. With reference to FIG. 13, a description is made as follows:

(1) The user information extracting step S38-1 of extracting user information from the user's terminal 10 to which advertisements have been delivered, and storing the extracted user information in the database 100.

In advertisement intermediation, the information of a user, viewing advertisements, is extracted to prevent advertisement costs from being charged in an unreasonable manner, because an advertisement fee is charged for each click or each exposure. Such information is the IP address, cookie, session, and search time of the user's terminal.

(2) The user information checking step S38-2 of checking whether identical information exceeding a reference value has been accumulated in the database at predetermined intervals, in the advertisement system 100.

It is checked whether the user information exceeds the reference value while the user information extracted in the user information checking step S38-2 is accumulated.

(3) The alarm step S38-3 of transmitting alarm information from the advertisement system 100 to the advertiser system 30 if it is determined that the identical user information has exceeded the reference value at the user information checking step S38-2.

If, as the result of checking the user information, it is determined that the same user information has exceeded the reference value in the predetermined time, this case is processed as an abnormal advertisement delivery, and notification about this fact is provided as an alarm to the advertiser system 30 having the advertisement information linked with the corresponding secondary keywords.

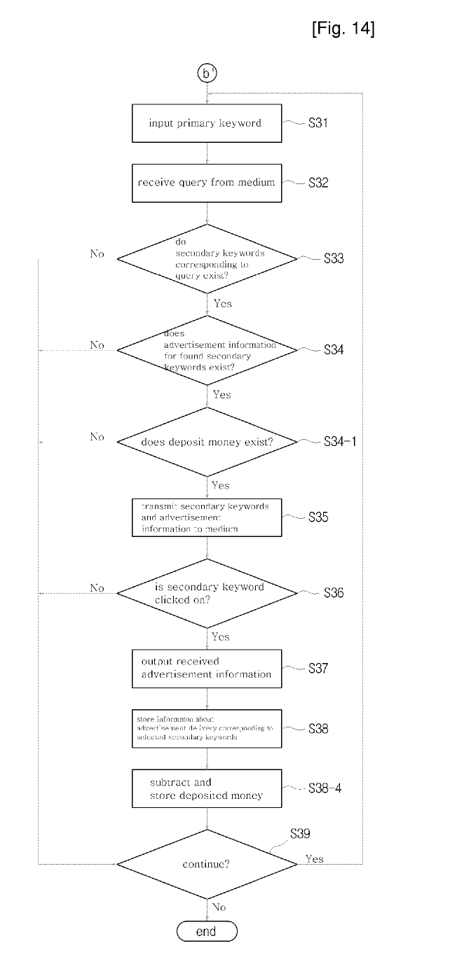

FIG. 14 is a detailed flowchart illustrating the third example of the advertisement delivery step through the keyword searching of FIG. 8. With reference to FIG. 14, a description is made as follows.

(1) The deposited money checking step S34-1 of checking whether the delivery of an advertisement is possible by calculating money to be consumed based on the remaining amount of deposited money stored in the database, and delivering an advertisement, if it is determined that the corresponding secondary keywords have been linked with the advertisement information and/or the advertiser system 30 at the advertisement information checking step S34, in the advertisement system 10.

When advertisement intermediation is charged for, an advertisement cost for each click or exposure is charged. In the advertising method according to the present invention, the deposited money is received in advance from the advertiser because the charging is processed based on a measured rate system. Such deposited money is consumed for every advertisement delivery in real time. Advertisement delivery is impossible if the remaining amount of deposited money is insufficient, so that the secondary keywords linked with corresponding advertisement information are removed from the list of secondary keywords.

(2) The deposited money information updating step S38-4 of performing update on the deposited money by consuming the remaining amount of the deposited money, which is stored in the database, corresponding to advertisement delivery cost, if the execution of advertisement is performed, in the advertisement system 100.

When the user connects to the advertiser system 30 by selecting a certain secondary keyword from the list of secondary keywords output to the user's terminal, this is regarded as the completion of advertisement delivery. In this case, corresponding advertisement costs are subtracted from the deposited money stored in a database, and a subtraction result is updated as new deposited money.

Methods of providing secondary keywords according to the embodiments of the present invention are described in detail with reference to the accompanying drawings below.

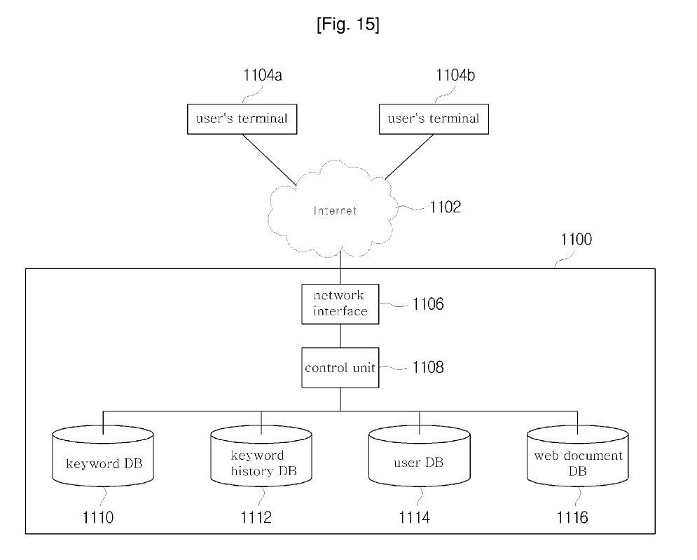

FIG. 15 is a diagram showing the construction of an overall system for providing a list of secondary keywords in accordance with the present invention. As shown in FIG. 15, a web server 1100 is connected to searcher or user terminals 1104a and 1104b via the Internet 1102. Furthermore, the web server 1100 includes a network interface 1106, a control unit 1108, and databases 1110, 1112, 1114, and 1116.

The network interface 1106, for example, is composed of a cable modem, and allows the control unit 1108 to communicate with the search or user terminals 1104a and 1104b via the Internet 1102 in a predetermined format.

The keyword database, as shown in FIG. 16, stores the secondary keywords corresponding to the primary keyword according to category. The keyword history database 1112, as shown in FIG. 22, stores keywords, which are exposed to a searcher after the searcher inputs a search word (primary keyword), in order of exposure. The user database 1114 stores the Identifications (IDs), password, concerns, and searched keywords of users who are formally registered in a web site provided by the web server 1100. The web document database 1116 stores web documents that are search targets.

When a search request signal associated with the primary keyword is input to the searcher's terminal 1104a or 1104b, the control unit 1108 searches web documents related to the primary keyword using the web document database 1116, and reads category information with respect to the primary keyword using the keyword database 1110 and then provides the read results to the user's terminal 1104a or 1104b through the network interface 1106. The control unit 1108 may provide priority secondary keywords (preferred secondary keywords) along with the category information with respect to the primary keyword. It is preferred that the priority secondary keyword be composed of secondary keywords having the highest primary keywords in respective categories. Furthermore, the control unit 1108 creates a history with respect to the primary keyword to be stored in the database 1112. When the searcher is a formally logged-in user, the control unit 1108 causes a search request for the primary keyword to be recorded in the user's database 1114 in conjunction with the user. When a searcher selects a category according to category with respect to the primary keyword, a category selection signal reaches the control unit 1108 via the Internet 1102 and, subsequently, the control unit 1108 reads the secondary keywords within the corresponding category from the keyword database 1110 and provides the read results to the user's terminal 1104a or 1104b.

FIG. 16 is a diagram illustrating an example of secondary keywords in accordance with the present invention. In the case where the primary keyword, as shown in FIG. 16, is “computer,” for example, the category may be subdivided into a computer product-related category and a computer industry-related category. The computer product-related category includes keywords, such as “brand PC,” “notebook,” “assembled Personal Computer (PC),” and “computer components,” and the computer industry-related category includes keywords, such as “education,” “media,” and “shopping.” For example, a category called the “brand PC” of the “computer” includes secondary keywords, such as “Samsung computer,” “Sambo computer,” “Hyunjoo computer,” and “Del computer”. The secondary keywords corresponding to a specific primary keyword are extracted using various methods. Based on statistics, keywords used for subsequent searches by searchers who used a primary keyword for a search may be used as secondary keywords. Such a method is called keyword extraction using “search pattern” in the present specification.

It is preferred that the arrangement order of secondary keywords in a specific category be determined according to possibility that a searcher, conducting a search using a primary keyword, well perform a continuous search. For example, the arrangement order may be determined individually or collectively taking into accounting the degree of similarity with the primary keyword, search frequency, the number of inserted advertisements, and the like. When the searcher selects a specific category, secondary keywords having high arrangement order are first provided to the user's terminal 1104a or 1104b, in contrast to second keyword having low arrangement order. For example, when a user, performing search using a keyword called “computer” selects a category with respect to “brand PC”, secondary keywords, such as “Samsung computer,” and “Sambo computer” are first provided to the user.

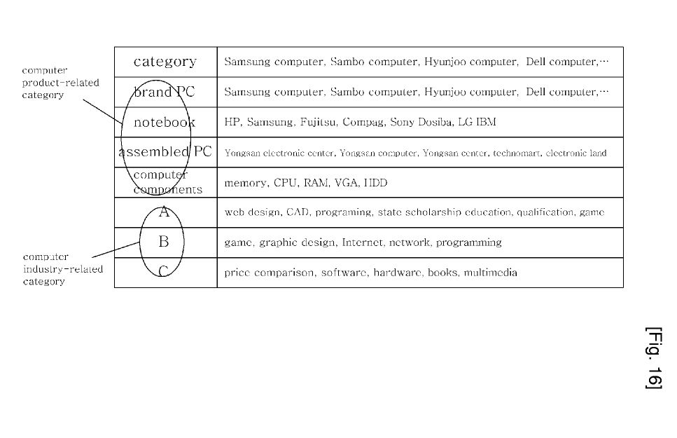

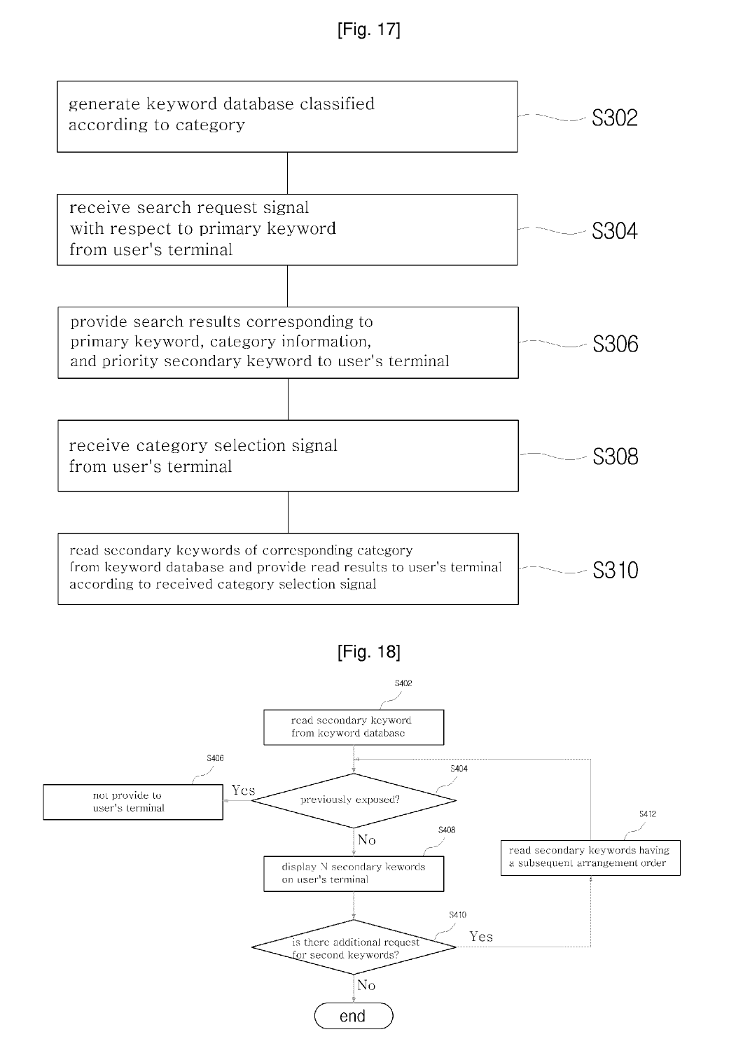

FIG. 17 is a flowchart illustrating the method of providing the secondary keywords in accordance with an embodiment of the present invention. As already described with reference to FIG. 16, a keyword database, in which secondary keywords are classified according to category with respect to a primary keyword, is generated at step S302.

The keyword database, in which the secondary keywords are classified according to category, may be generated by a method using a pattern category, and the pattern category refers to a category that expresses a list of pattern keywords, which is generated based on a list of keyword at users' search requests through a search medium, such that a person who does not have special knowledge can instinctively understand it.

That is, the present invention designates a list of pattern keywords, which has been collected by a search medium, as a commonly understandable range of information search, constitutes a list of pattern categories, and presents the constituted result to a user.

For example, a list of keywords which is sequentially searched for by a user, having searched for “computer,” may be variously represented as follows:

\textcircled{1} Samsung computer-Sambo computer-Hyunjoo computer-Dell computer- . . .

\textcircled{2} computer design-CAD-programming-qualification- . . .

\textcircled{3} price comparison-software-hardware-books- . . .

When the list of keywords described above is listed again according to pattern category of the present invention, the following list can be provided.

\textcircled{1} brand: Samsung computer-Sambo computer-Hyunjoo computer-Dell computer- . . .

\textcircled{2} education: computer design-CAD-programming-qualification- . . .

\textcircled{3} shopping: price comparison-software-hardware-books- . . .

Thereafter, when the user's terminal 1104a or 1104b connects to the web server 1100 via the Internet 1102 and requests a search with respect to a specific keyword (primary keyword) at step S304, the web server 1100 searches the web document database 1116 and reads data related to the primary keyword at step 306. Furthermore, the web server 1100 searches the keyword database 1110 and reads category information with respect to the primary keyword, so that the read results constitute a web page having a predetermined format and are then provided to the user's terminal 1104a or 1104b, at step S306.

A predetermined number of secondary keywords, for example, five secondary keywords, may all be provided at step S306 before the user selects a category. In the present specification, the provided secondary keywords are referred to as “priority secondary keywords.” With reference to FIG. 2, for example, when the primary keyword is “computer,” the keywords, such as “Samsung computer,” “HP”, “Yongsan electronic center,” “memory,” “web design,” “game,” and “price comparison,” which are arranged at the first locations of respective categories, may be provided as the priority secondary keywords. Furthermore, keywords (pattern keywords), which are statistically investigated that probability of being searched for by the same searcher after a primary keyword search is high regardless of category, may be provided as priority secondary keywords, like the conventional method.

When the user selects a category appropriate to a search target according to the provided category information at step S308, the web server 1100 read the secondary keyword of the corresponding category from the keyword database 1110 and provides the read results to the user terminal 1104a or 1104b at step S310.

FIG. 18 is a detailed flowchart of the step of providing the secondary keywords in FIG. 14. When a category selection signal is received from the user terminal 1140, the secondary keywords are read from the keyword database 1110 at step S402. Thereafter, it is checked whether search results with respect to the primary keyword have been exposed in a search process after a search request at Step 404. The exposure check may be performed with reference to the keyword history database 1112. If, as the result of the check, it turns out that the search results have already been exposed to a user, the search results are not provided to the user terminal 1104a and 1104b, and different secondary keywords in the same category are read at step S402. Such a process is repeated and, therefore, N secondary keywords, which have not been previously exposed, are displayed on the user terminal 1104a or 1104b at step S408.

Thereafter, the reception of an additional request signal for secondary keywords from the user is waited at step S410. If the signal is received, secondary keywords having a next arrangement sequence are read from the same category, at step S412, and are provided to the user terminal 1104a or 1104b after checking for exposure at step S408. In the present embodiment, a Graphic User Interface (GUI), as shown in FIG. 24, is displayed in left and right direction triangle form on the user terminal 1104a or 1104b to generate the additional request signal for the secondary keywords, and is configured such that different secondary keywords are displayed on the user terminal 1104a or 1104b if a user clicks the triangles using a mouse. With reference to FIG. 16, for example, when the user selects a category called “brand PC” while conducting a search using a primary keyword “computer”, and N is 3, “Samsung computer,” “Sambo computer,” and “Hyunjoo computer,” are initially provided as secondary keywords. Thereafter, when the additional request signal is received from the user terminal 1104a or 1104b, 3 keywords following “Sambo computer” may be provided as secondary keywords, and 3 keywords after “Dell computer” may also be provided as secondary keywords.

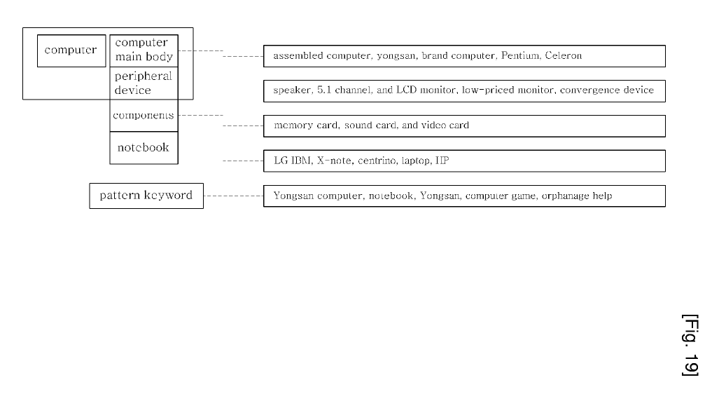

FIG. 19 is a diagram illustrating an example in which a category and the secondary keywords are displayed on searcher terminals 1104a and 1104b in the case in which the primary keyword is “computer” in accordance with the present invention. In FIG. 17, “computer main body”, “peripheral devices,” “components,” and “notebook” are provided as category information with respect to a primary keyword, “computer.” Furthermore, a pattern keyword type of “Yongsan computer,” “notebook,” “Yongsan,” “computer game,” and “orphanage help” are provided as priority secondary keywords. Furthermore, when a searcher, for example, selects a category called “computer main body,” “assembled computer,” “Yongsan,” “brand computer” and the like are provided as secondary keywords.

In this manner, so-called “targeting keywords,” which are associated with the field of interest of the searcher, along with pattern keywords may be divided and generated and may be exposed to the searcher at the same time. Accordingly, the searcher can quickly reach his or her search target.

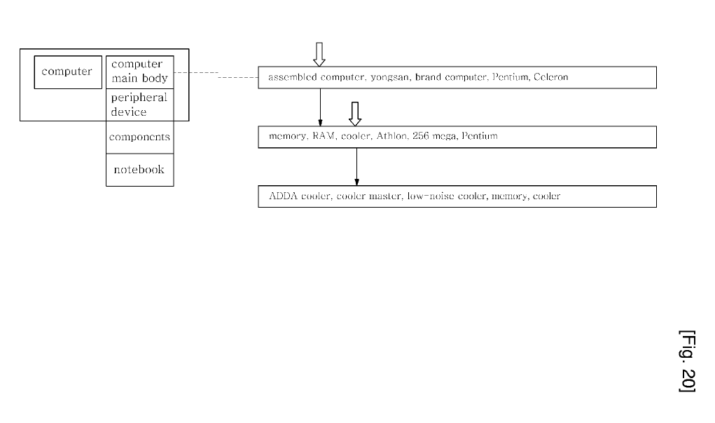

FIG. 20 is a diagram illustrating an example in which the secondary keywords, already exposed, are not exposed by subsequent searching within a selected category, in accordance with the present invention, and shows an example in which “computer” is input as a primary keyword and “computer main body”, “peripheral devices,” “components,” and “notebook” are provided as category information. When “computer main body” is selected from among 4 categories, “assembled computer,” “Yongsan,” “brand computer,” “Pentium,” and “Celeron” are provided as secondary keywords. When, from among them, “assembled computer” is selected (∇), “memory,” “RAM”, “cooler,” “CPU,” “Athlon,” “256 mega,” and “Pentium” are classified as secondary keywords in the keyword database 110. However, since, of the secondary keywords, “Pentium” is a keyword that has already been exposed as a result of the selection of the category, “computer main body,” it is not exposed again. Likewise, when “cooler” is selected (∇), “ADDA cooler,” “cooler master,” “low-noise cooler,” “memory,” and “cooler” are classified as secondary keywords. However, since “memory” and “cooler” have already been exposed, they are not exposed again.

The present invention prevents already exposed keywords from being exposed again and, therefore, prevents searches from being impeded by unnecessarily and repeatedly exposing keywords that are ignored by the searcher. Accordingly, only keywords that might be useful in finding a search target are exposed to the searcher at an early stage.

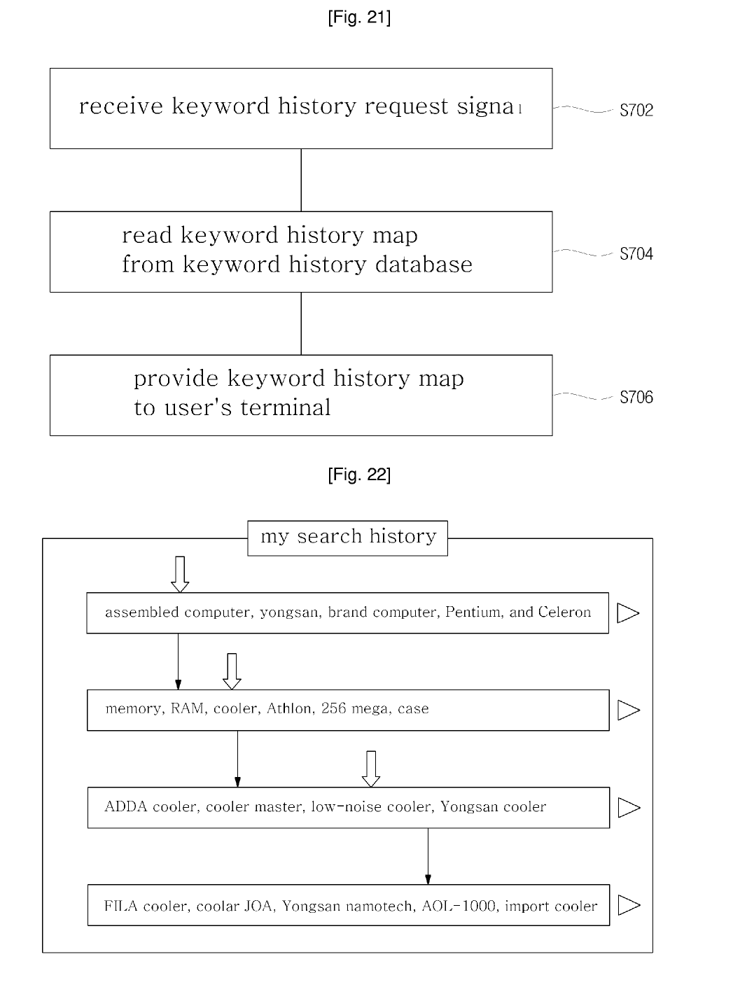

FIG. 21 is a flowchart illustrating a method of providing a keyword history map in accordance with the present invention. First, when a keyword history request signal is received from the user terminal 1104a or 1104b at step S702, the control unit 1108 forms a web page by reading the keyword history database 1112 at step S704, and then provides a keyword history map to the user terminal 1104a or 1104b at step S706. An example of the keyword history map is shown in FIG. 20. In FIG. 22, a downward triangle indicates the exposure of a keyword selected by a searcher, and a rightward triangle indicates the exposure of different secondary keywords within an identical category. In the keyword history map, keywords, which are searched for after a primary keyword is input by the searcher, are displayed in searched order. Furthermore, in the keyword history map, keywords, which have not been searched by the searcher but have been exposed together, are displayed together.

The searcher easily confirms through the keyword history map which processes they conduct for a search, thus more easily reaching a search target.

The control unit 1108 records secondary keywords, which are provided to the user terminal 1104a and 1104b, in keyword history database 1112 according to the level or order thereof after the primary keyword has been received from the user terminal 1104a or 1104b, so that the keyword history map may be generated. In this case, secondary keywords, which are classified as an identical category and displayed together, are defined as being in the same level. For example, in FIG. 8, “assembled computer,” “Yonngsan,” “brand computer,” “Pentium,” and “Celeron” are keywords having the same level. “memory,” “RAM,” “cooler,” “CPU”, “Athlon,” “256 mega,” and “case,” which are provided at a search request with respect to “assembled computer,” are also keywords having an identical level.

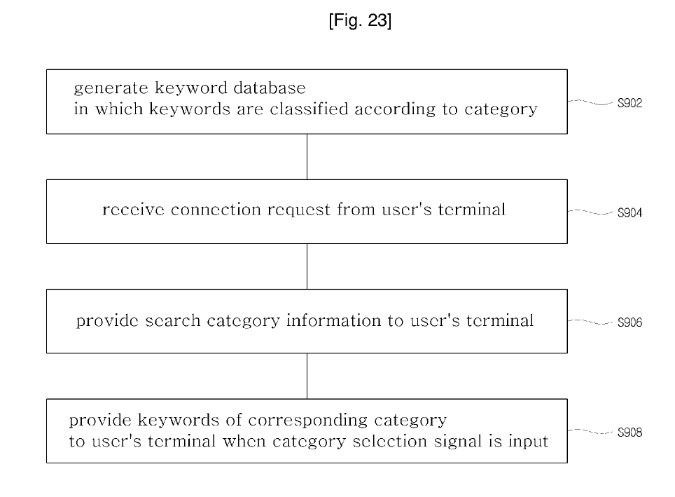

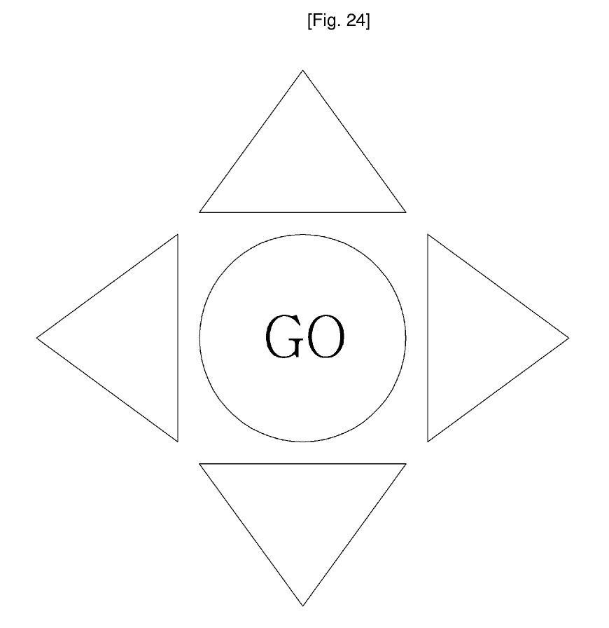

FIG. 23 is a flowchart illustrating a method of providing the secondary keywords in accordance with another embodiment of the present invention, and illustrates a method of providing related keywords from a web site, which provides categories, without the input of a search word. First, a keyword database, in which keywords are classified according to predetermined categories, is generated at step S902. When a connection request is received from the user terminal 1104a or 1104b at step S904, the web server 1100 immediately provides search category information to the user terminal 1104a or 1104b at step S906. Thereafter, when a category selection signal depending on category information is received from the user terminal 1104a or 1104b, the web server 1100 provides the keywords of a corresponding category to the user terminal 1104a or 1104b according to the input category selection signal.

In the embodiment shown in FIG. 17, when a searcher inputs a search word (primary keyword), category information corresponding to the primary keyword is provided to the user terminal 1104a or 1104b. However, in the embodiment shown in FIG. 23, even when the searcher only connects to the web server 1100 without the input of the search word category, information is provided to the user terminal 1104a or 1104b. The category in FIG. 23 corresponds to a large classification in an entire search field, and the category in FIG. 15 corresponds to a small classification for search words input by the searcher. Accordingly, both may be merged according to search level.

FIG. 24 is a diagram illustrating a search jog interface displayed on a user terminal 1104a or 1104b in accordance with the present invention.

The leftward triangle and rightward triangle of FIG. 22 indicates the display of different secondary keywords within an identical level, the upward triangle indicates the display of a previous level of secondary keywords, and the downward triangle indicates the display of categories with respect to search words. Furthermore, the central circle indicates the display of the keyword history map. For example, when a searcher clicks the rightward triangle using a mouse, the web server 1100 causes the different keywords within an identical level to be displayed on the user terminal 1104a or 1104b.

The above-described embodiments are only examples for allowing those skilled in the art to easily understand and implement the present invention, and are not intended to limit the scope of the present invention. Accordingly, those skilled in the art must note that various modifications or changes to the embodiments are possible. The scope of the present invention is fundamentally defined by the claims described later.

### INDUSTRIAL APPLICABILITY

In accordance with the present invention described above, a user conducts a search using a primary keyword having a relatively comprehensive meaning and then conducts searches more detailed secondary keywords, so that information and/or commodity sought by the user can be easily found and checked. Meanwhile, an advertiser discloses his or her information and/or commodity to effective customers, connected through corresponding secondary keywords, so that the efficiency of advertising can be greatly improved.

Furthermore, the usefulness of words well-known as search words can be increased, so that, when an advertiser, utilizing an Internet keyword search method as an advertisement means, uses keywords directly related to information and/or commodity provided by the advertiser, the selection width thereof can be widened.

In accordance with the method of providing a list of secondary keywords of the present invention described above, an additional keyword is related to search categories and is provided to the searcher. Secondary keywords are conventionally extracted and provided only by the search pattern of the searcher. In contrast, in the present invention, secondary keywords are extracted by combining the searcher's search target and search pattern secondary keyword, so that secondary keywords closely related to the search target can be provided to the searcher. Furthermore, a keyword input by the searcher and keywords provided to the searcher as the secondary keywords thereof are displayed in a history map form, so that the searcher can easily check a search process and quickly reach a search target.

Furthermore, keywords, which have already been searched for or have been ignored in the process of inputting a search word and the process of exposing the secondary keywords, are never provided as secondary keywords again, so that searches can be performed using only keywords suitable for the search target search. Furthermore, a GUI having a search jog function is displayed on the terminal of the searcher, so that the selection of categories by the searcher and the additional request for secondary keywords are further facilitated.

Further, a targeting keyword search rate can be improved through the presentation of targeting keywords to fit the interest field of the searcher. Accordingly, since the advertisement value of targeting keyword advertisement increases, advertisement registration using targeting keywords can be increased and, therefore, keyword advertisement sales through targeting keywords can be increased.

1. An advertisement system having an FO server, the FO server comprising:
a keyword database for storing primary keywords, which will be input into a search window of a web browser driven by a medium server system, and secondary keywords, which will be output as search results when an advertiser designates and selects a certain word;
an advertiser database for storing advertisement information, having a Uniform Resource Locator (URL), in conjunction with the primary and secondary keywords;
an advertisement server having a keyword list generation module for extracting the secondary keywords, which are mapped according to a query of the medium server system for primary keyword from the keyword database, and generating a list by linking the secondary keywords with the advertisement information stored in the advertiser database, and a medium communication module for outputting the list through the web browser of the medium server system for an Internet user and receiving selection information with respect to the list;
a LOG server having an advertisement delivery information module for checking delivery of the corresponding advertisement information that is linked with the secondary keywords selected from the list by the Internet user, and generating delivery information data;
an advertisement delivery information database for storing the delivery information data; and
an advertisement delivery detail reading module for extracting requested delivery information data from the advertisement delivery information database at an online request from an advertiser and outputting the extracted delivery information data.

2. The advertisement system according to claim 1, wherein the LOG server further comprises:
a user information module for checking at least one of an Internet Protocol (IP) address, cookie, session and search time of the user who selected the secondary keywords, and generating user information data;
an alarm module for checking whether identical information is accumulated at predetermined intervals by analyzing the user information data, and performing communication with the advertiser of the corresponding keyword advertiser through mail and/or Short Message service (SMS) when an accumulated amount thereof exceeds a reference value; and
a user information database for storing the user information data, the user information database being configured to operate in conjunction with the FO server, so that advertiser can read the user information data.

3. The advertisement system according to claim 1, wherein the FO server further comprises a keyword amendment module that operates in conjunction with the keyword database and the advertiser database, and performs additions, deletions and changes on the keywords associated with the advertisement information at an on-line request from the advertiser.

4. The advertisement system according to claim 1, further comprising an payment database for storing cost data with respect to deposited money that has been deposited by the advertiser for advertisement costs, an amount of money that has been consumed depending on advertisement delivery and remaining amount of deposited money, operating in conjunction with the keyword list generation module so that the cost data is utilized as a parameter, which is applied to generation of the list, by calculation of an amount of money to be consumed depending on a remaining amount of deposited money and advertisement delivery, and operating in conjunction with the FO server so as to allow the advertiser to read the cost data;
wherein the FO server further comprises an accounting module for updating the cost data according to consumption of the deposited money caused by advertisement delivery, and additions to the deposited money caused by depositing money.

5. The advertisement system according to claim 1, further comprising:
a medium query information database for storing information data about queries of the medium server system; and
a keyword complement module for extracting and analyzing the information data of the medium query information database, performing additions, deletions and changes on the primary keywords and the secondary keywords stored in the keyword database, and amending mapping between the primary keyword and the secondary keywords.

6. The advertisement system according to any one of claims 1 to 5, further comprising a note system, the note system comprising:
a message delivery module for outputting a note form, which is attached to the list output to the medium server system, to a user's terminal according to selection of the Internet user, and sending a prepared message to the advertiser on-line; and
a note database for storing details of the prepared message as data.

7. An advertising method on an Internet using an advertisement system having a user's terminal, a medium server system, an advertiser system, and at least one database and server, the method comprising:
the primary keyword input step of transmitting and inputting a primary keyword from the user's terminal to the medium server system;
the query transmission step of transmitting a query regarding the primary keyword from the medium server system to the advertisement system;
the secondary keyword search step of determining whether one or more secondary keywords, which are mapped depending on relation to the primary keyword, exist in the database, in the advertisement system;
the advertisement information checking step of checking whether the one or more secondary keywords, which have been searched for, are linked with the advertisement information and/or the advertiser system, in the advertisement system;
the secondary keyword transmission step of transmitting the one or more secondary keywords to the user's terminal through the medium server system if it is determined that corresponding secondary keywords have been linked with the advertisement information and/or the advertiser system at the advertisement information checking step, in the advertisement system;
the advertisement information output step of connecting to the advertisement information and/or the advertiser system that is linked with the corresponding secondary keywords if one of the secondary keywords is clicked on or moused over by the user's terminal; and
the advertisement delivery information storing step of transmitting and storing delivery information data about advertisement delivery details, which result from the connection of the user's terminal to the advertisement information and/or the advertiser system through the secondary keywords, to and in the database of the advertisement system.

8. The advertising method according to claim 7, further comprising:
the user information extracting step of extracting user information from the user's terminal to which advertisements have been delivered, and storing the extracted user information in the database;
the user information checking step of checking whether identical information of an amount exceeding a reference value and has been accumulated in the database at predetermined intervals, in the advertisement system; and
the alarm step of transmitting alarm information from the advertisement system to the advertiser system if it is determined that the identical user information has exceeded the reference value at the user information checking step.

9. The advertising method according to claim 7 or 8, further comprising:
the deposited money checking step of checking whether the delivery of an advertisement is possible by calculating money to be consumed based on to the amount of remaining deposited money stored in the database; and delivering an advertisement, if it is determined that the corresponding secondary keywords have been linked with the advertisement information and/or the advertiser system at the advertisement information checking step, in the advertisement system; and
the deposited money information updating step of performing update on the deposited money by consuming the remaining amount of the deposited money, which is stored in the database, corresponding to advertisement delivery cost, if an advertisement is delivered, in the advertisement system.

10. The advertising method according to claim 7, wherein, at the secondary keyword transmitting step, the secondary keywords are transmitted in a sentence form including desired secondary keywords to be transmitted.

11. A method of providing a list of secondary keywords, comprising the steps of:
receiving a search request signal for a primary keyword;
providing search results and category information about the primary keyword when the search request signal for the primary keyword is input;
receiving a category selection signal based on the category information; and
providing secondary keywords of a corresponding category in response to the input category selection signal.

12. The method according to claim 11, further comprising the step of providing priority secondary keywords that correspond to the primary keyword, when the search request signal associated with the primary keyword is input.

13. The method according to claim 11 or 12, wherein the secondary keywords are extracted from keywords that have been previously searched for by users using the primary keyword.

14. The method according to claim 11 or 12, wherein the provided secondary keywords are keywords that are not previously exposed after a primary keyword search.

15. The method according to claim 11, wherein the secondary keywords are arranged depending on a degree of similarity with the primary keyword.

16. The method according to claim 11, wherein the secondary keywords are arranged according to search frequency.

17. The method according to claim 11, wherein the secondary keywords are arranged according to the number of inserted advertisements.

18. The method according to any one of claims 15 to 17, wherein, of the secondary keywords corresponding to the primary keyword, the priority secondary keyword is positioned first.

19. The method according to claim 11 or 12, further comprising the steps of:
receiving a signal for selecting one from among the provided secondary keywords; and
providing search results for the selected secondary keyword.

20. The method according to claim 19, further comprising the steps of:
receiving a keyword history request signal; and
allowing searched keywords to be displayed according to search order after the searching for the primary keyword.

21. The method according to claim 11 or 12, wherein a predetermined number of secondary keywords are provided at one time, and another predetermined number of secondary keywords are provided at an additional request of a user.

22. The method according to claim 21, wherein the additional request is received through an interface for indicating directions.

23. The method, according to claim 11 or 12, wherein the category information is provided in response to a request signal received through the interface.

24. The method, according to claim 11 or 12, further comprising the step of generating a keyword database in which the secondary keywords corresponding to the primary keyword are classified according to category;
wherein the secondary keywords are read from the keyword database and provided.

25. A method of providing a list of secondary keywords, comprising the steps of:
generating a keyword database in which keywords are classified according to predetermined category;
receiving a keyword;
providing category information corresponding to the input keyword; and
reading keywords of a corresponding category from the keyword database and providing the read results, if selection of the category is performed according to the provided category information.

26. A method of providing a list of secondary keywords, comprising the steps of:
generating a keyword database in which keywords are classified according to predetermined category;
providing search category information in response to a request for connecting to a web site; and
providing keywords of a corresponding category in response to a category selection signal when the category selection signal is input according to the provided category information.

27. A web server for providing a list of secondary keywords, comprising:
a keyword database configured such that the secondary keywords corresponding to a primary keyword are classified according to predetermined category;
means for providing search results, for the primary keyword, category information, and priority secondary keywords, when a search request signal resulting from the primary keyword is input; and
means for reading secondary keywords of a corresponding category from the keyword database in response to a category selection signal and providing the read results, when the category selection signal is input based on the provided category information.
